(19) United States
(12) Patent Application Publication
(10) Pub. No.: US 2015/0113408 A1
(43) Pub. Date: Apr. 23, 2015

(54) AUTOMATIC CUSTOM SOUND EFFECTS FOR GRAPHICAL ELEMENTS

(71) Applicant: Apple Inc., Cupertino, CA (US)

(72) Inventor: Aaron M. Eppolito, Santa Cruz, CA (US)

(73) Assignee: Apple Inc., Cupertino, CA (US)

(21) Appl. No.: 14/058,185

(22) Filed: Oct. 18, 2013

(51) Int. Cl. G06F 3/16

(52) U.S. Cl. CPC G06F 3/167
USPC 715/726

(57) ABSTRACT

A method of automatically adding sound effects for graphical elements is provided. The method analyzes a set of properties of a graphical element. The method selects a set of sound effects clips based on the analysis of the graphical element properties. The method identifies the starting time of each sound effects clip in the selected set of sound effects clips based on the analysis of the graphical element. The method adjusts the duration of each sound effects clip in the set of sound effects clips based on the properties of the graphical element. The method schedules the selected set of sound effects clips for play back. The analyzing, selecting, identifying, and adjusting operations are performed without human intervention.

### BACKGROUND

Currently, many media editing applications for creating media presentations exist that composite several pieces of media content such as video, audio, animation, still image, etc. Such applications give graphical designers, media artists, and other users the ability to edit, combine, transition, overlay, and piece together different media content in a variety of manners to create a resulting composite presentation. Examples of media editing applications include Final Cut Pro® and iMovie®, both sold by Apple® Inc.

The media editing applications include a graphical user interface (“GUI”) that provides different tools for creating and manipulating media content. These tools include different controls for creating a movie by selecting source video clips from a library and adding background music. The tools allow addition of titles, transitions, photos, etc., to further enhance the movie.

The tools further allow manual selection and addition of sound effects to different visual elements or graphical cues such as titles and transitions. Often, in professionally produced multimedia content, sound designers craft sound effects (or audio effects) to augment graphical cues. For instance, the sounds that accompany titles in broadcast sports or news are typically created, chosen, placed, timed, and leveled manually by someone trained in sound design to make a specific storytelling or creative point without the use of dialogue or music.

However, these visual elements can have different lengths and the sound effects can have different clips for coming-in and going-out sounds. Other video clips and visual elements can also start shortly after any visual element. Therefore, the sound effects added for each visual element require a lot of efforts to be manually trimmed, faded-in, faded-out, and spotted by an expert to the right place on the clip. In addition, different movies can have different volume levels and the volume level of the sound effects has to be manually adjusted to properly blend with the audio for the rest of the movie.

### BRIEF SUMMARY

Some embodiments provide an automated method to add custom sound effects to graphical elements added to a sequence of images such as a sequence of video clips in a movie. The method analyzes the properties of graphical elements such as titles, transitions, and visual effects added to the video sequence. The properties include the type, style, duration, fade-in, fade-out, and other properties of the graphical elements.

The method then automatically and without human intervention selects one or more sound effects clips from a library for each graphical element. The method then trims each sound effects clip to fit the required duration of the graphical element. The method also fades the edges of the audio clip to ensure smoothness.

The method further analyzes the surrounding content and adjusts the volume of each sound clip to an appropriate level based on adjacent content. The method then schedules the sound effects clips along with other clips in the sequence to pay during playback or monitoring.

The uses of the disclosed method include, but are not limited to, applying sounds to transitions between media clips, applying sounds in conjunction with animated titles, adding sounds to visual effects or filters, etc. The method is also utilized by any animation engine that requires sound effects to be added to animated visual elements.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a graphical user interface of a media editing application that automatically adds sound effects to an added transition in some embodiments of the invention.

FIG. 2 illustrates a user interface of a media editing application in some embodiments of the invention.

FIG. 3 illustrates another example of a user interface of a media editing application in some embodiments of the invention.

FIG. 4 illustrates a user interface used to add a graphical element to a video sequence in some embodiments of the invention.

FIG. 5 conceptually illustrates a process for automatically adding sound effects to graphical elements such as transitions and titles in a sequence of video clips in some embodiments of the invention.

FIGS. 6A and 6B conceptually illustrate automatic application of a sound effects clip to a graphical element in some embodiments of the invention.

FIGS. 7A and 7B conceptually illustrate automatic application of a sound effects clip to the same graphical element as in FIGS. 6A and 6B when the surrounding content has a lower audio volume.

FIG. 8 conceptually illustrates a process and provides further details for automatically adding sound effects to graphical elements in some embodiments of the invention.

FIGS. 9A and 9B conceptually illustrate automatic application of a set of sound effects that include more than one sound clip to a graphical element in some embodiments of the invention.

FIG. 10 illustrates a user interface used to add a title to a video sequence in some embodiments of the invention.

FIG. 11 illustrates another example of a user interface used to add a title to a video sequence in some embodiments of the invention.

FIG. 12 conceptually illustrates the graphical element and the corresponding sound effects clips of FIG. 9 in more details.

FIG. 13 conceptually illustrates the video clips of FIGS. 9A, 9B, and 12 when a different graphical element is added to the second video clip.

FIGS. 14A and 14B conceptually illustrate an example of adding sound effects to overlapping graphical elements in some embodiments of the invention.

FIGS. 15A and 15B conceptually illustrate another example of adding sound effects to overlapping graphical elements in some embodiments of the invention.

FIGS. 16A and 16B conceptually illustrate another example of adding sound effects to overlapping graphical elements in some embodiments of the invention.

FIGS. 17A and 17B conceptually illustrate another example of adding sound effects to overlapping graphical elements in some embodiments of the invention.

FIG. 18 conceptually illustrates the high-level software architecture for automatically adding sound effects to graphical elements in some embodiments of the invention.

FIG. 19 conceptually illustrates the high-level software architecture for automatically adding sound effects to graphical elements generated by an animation engine in some embodiments of the invention.

FIG. 20 is an example of an architecture of such a mobile computing device. Examples of mobile computing devices include smartphones, tablets, laptops, etc.

FIG. 21 conceptually illustrates another example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for automatically adding sound to animated graphical elements (also referred to herein as visual elements or visual cues) such as title of a video clip or transitions between the video clips. The method analyzes metadata and audio from the video clip. The method then automatically adds sound effects to the graphical elements. The method also retimes and trims the sound effects to fit. The method also analyzes the surrounding content and adjusts the volume and fades the sound based on the analysis of the surrounding content.

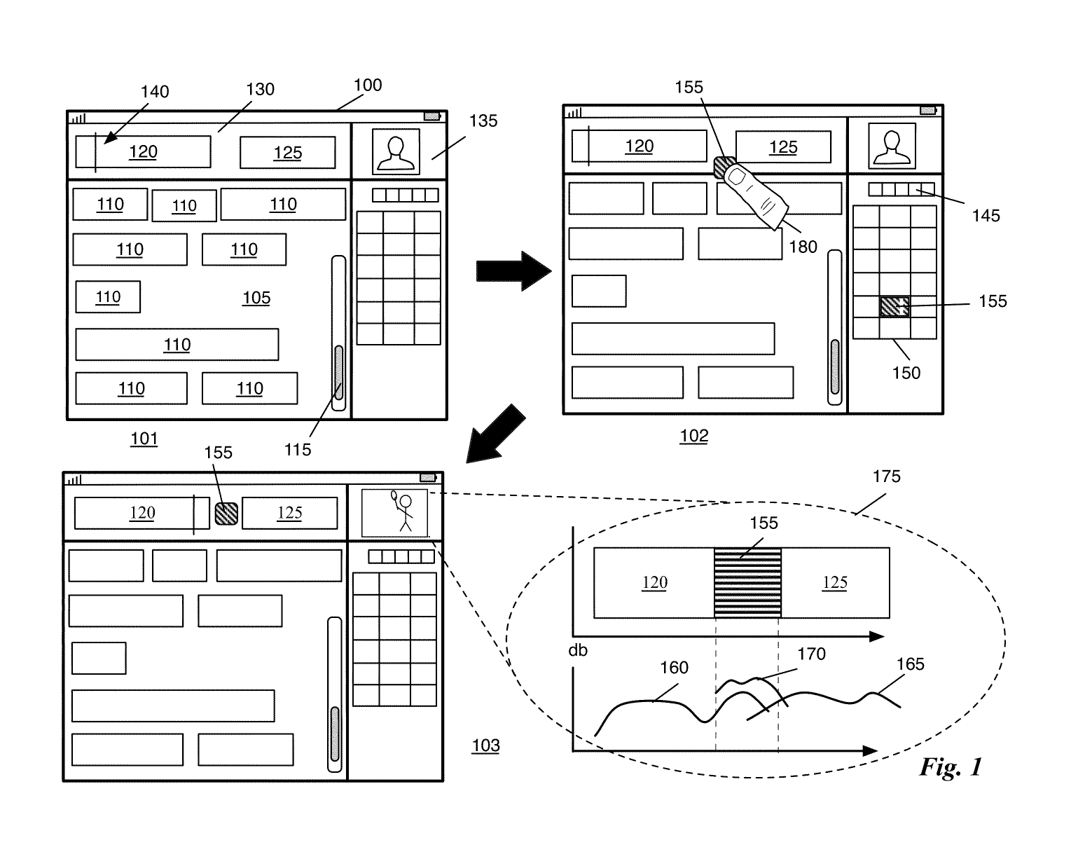

FIG. 1 conceptually illustrates a graphical user interface (“GUI”) 100 of a media editing application that automatically adds sound effects to added graphical elements such as titles, transitions, and visual effects in some embodiments of the invention. The GUI is shown in three stages 101-103. As shown in stage 101, the GUI includes a display area 105 that shows a library of video clips 110. Additional video clips in the library can be viewed by using scroll down control 115. One or more of these video clips are selected for a project to create a movie. These video clips 120 and 125 are shown in project display area 130. Any number of video clips can be selected for a project.

The video clips in a movie can be monitored by activating a control (such as hitting the space bar key) to start playing the movie. The movie is played in the monitoring area 135. When the movie is stopped, the frame immediately below the play head 140 is displayed in the monitoring area 135.

In stage 102, a control 145 is activated to show a set 150 of visual elements such as titles, transitions, visual filters, etc., to add to the movie. In this example, the added visual element 155 is a transition and is added (as conceptually shown by a finger 180) between the two video clips 120 and 125. In stage 103, automatically and without any further inputs from a human, sound effects are added to the movie for the visual element. The sound effects are added based on the properties of the visual elements such as the type (e.g., transition or title), style (e.g., cut, swipe, spin), the number of events in the visual element (e.g., coming in, zooming in, zooming out, fading out), duration, etc.

Addition of the sound effects clip 170 is conceptually shown in the exploded area 175. The sound clips 160 and 165 corresponding to video clips 120 and 125 are also shown in the exploded area 175.

Several more detailed embodiments of the invention are described in sections below. Section I describes automatically adding custom sound effects for graphical elements in some embodiments. Next, Section II describes the software architecture of some embodiments. Finally, a description of an electronic system with which some embodiments of the invention are implemented is provided in Section III.

### I. Automatically Adding Custom Sound Effects for Graphical Elements

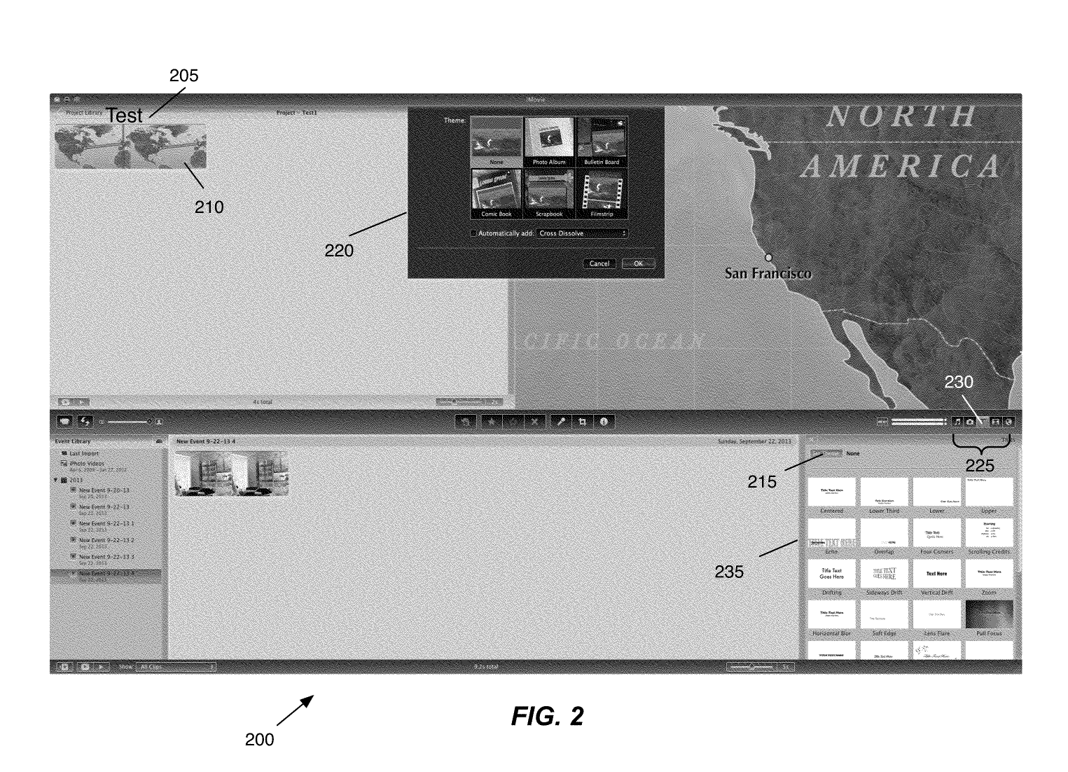

In some embodiments, a video editing project starts by creating a project and adding video clips to the project. A movie can be created by adding one or more video clips to a project. FIG. 2 illustrates a user interface 200 of a media editing application in some embodiments of the invention. As shown, a project 205 is created and a video clip 210 is included in the project.

At any time a theme can be selected and applied to the video project. Each theme provides a specific look and feel for the edited video. Examples of themes include modern, bright, playful, neon, travel, simple, news, CNN iReport, sports, bulletin board, and photo album. In the example of FIG. 2, a control 215 is activated to provide a list 220 of the available themes. A theme selected from the list 220 is applied to all video clips in the project. The user interface 200 also provides a set of tools 225 to allow manual selection and addition of different graphical elements such as transitions and titles to a movie.

In FIG. 2, control 230 is activated to provide a list 235 of several title styles to add to the clip 210. After a theme is selected and applied to a video project, additional theme related graphical elements become available to add to the project. For instance, when no themes are selected for a movie, there may be eight possible transitions to choose. When a theme such as sports is selected for the movie, six additional theme-related transitions may be added to the possible transitions to choose.

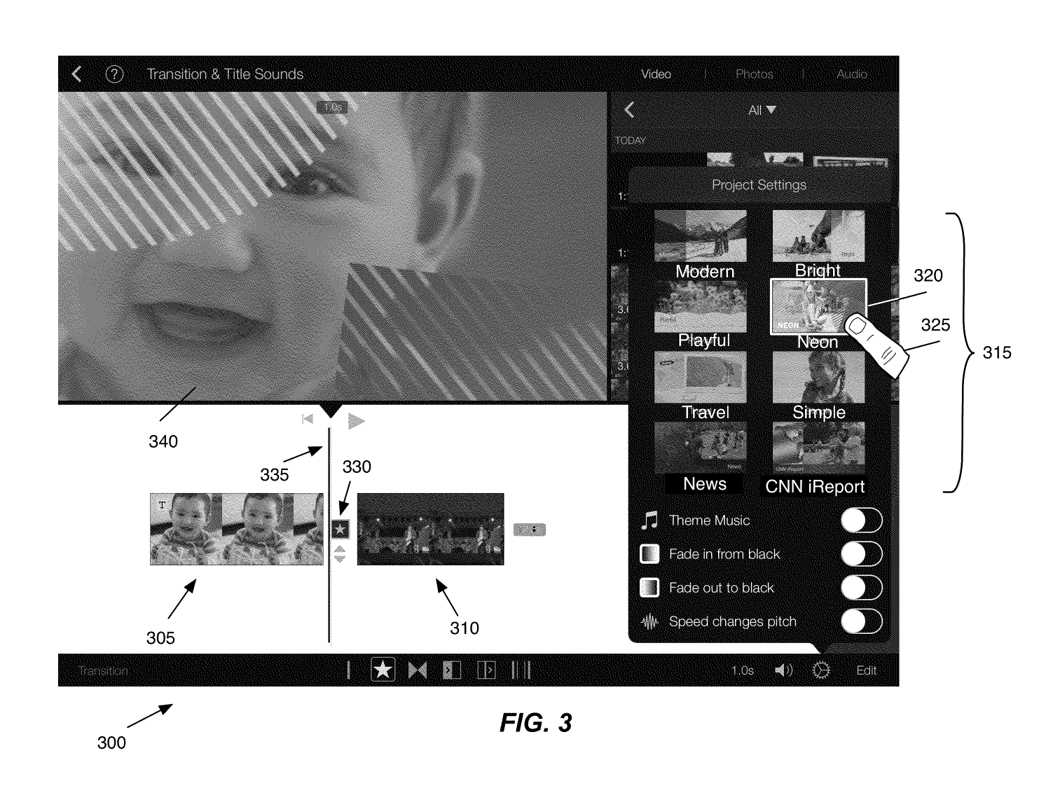

FIG. 3 illustrates another example of a user interface 300 of a media editing application in some embodiments of the invention. As shown, a project that includes two video clips 305 and 310 is created. In addition, a list 315 of available themes is displayed. The list includes modern, bright, playful, neon, travel, simple, news, and CNN iReport themes. In the example of FIG. 3, the neon theme 320 is selected (as conceptually shown by a finger 325 touching the neon theme 320 in the list 315 of available themes).

In addition, the figure shows that a theme related transition 330 is added between the two video clips 305 and 310. In this example, the play head 335 is at the beginning of the transition and a transition related to neon theme is played in the preview display area 340.

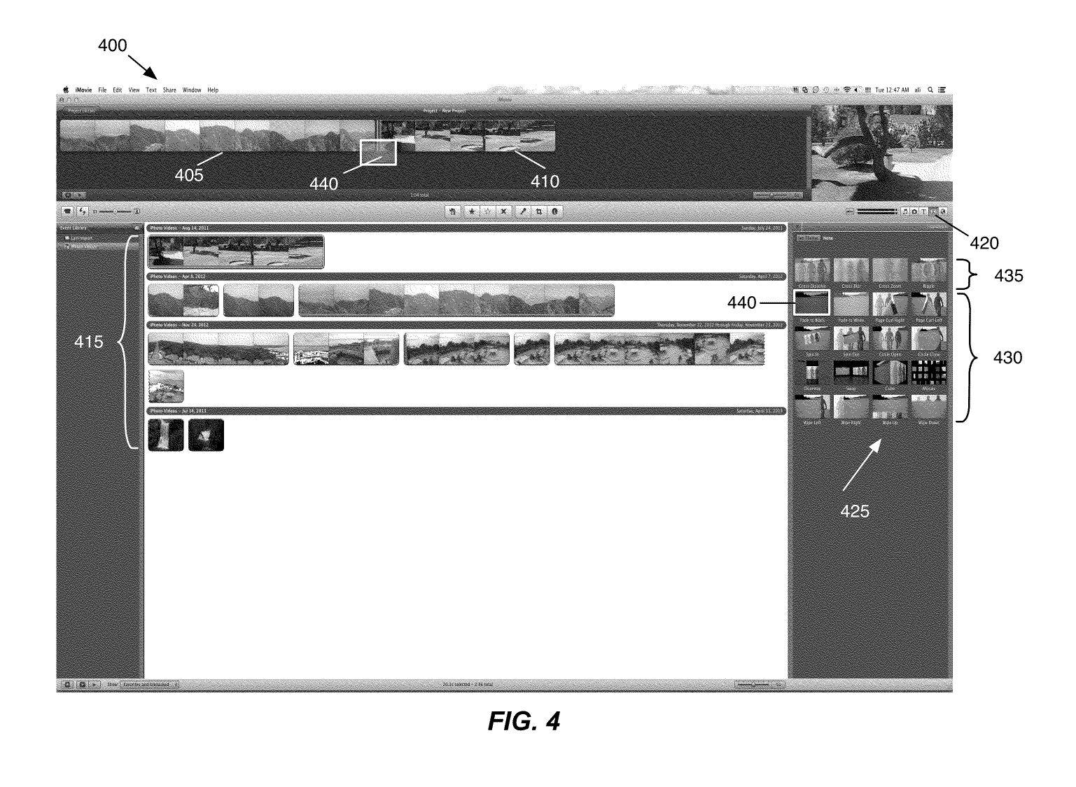

FIG. 4 illustrates a user interface 400 used to add a graphical element to a video sequence in some embodiments of the invention. Video clips 405 and 410 are selected from a library 415 of video clips to create a video sequence. As shown, a control 420 is activated to display a list 425 of available transitions to add to the sequence of video clips. Examples of available transition styles include cut, cross-dissolve, slide, wipe, fade thru white, fade thru black, cross blur, cross zoom, ripple, page curl right, page curl left, spin in, spin out, circle open, circle close, doorway, swap, cube, and mosaic. In addition, some embodiments provide at least one transition for each theme. For instance, if the available themes are modern, bright, playful, neon, travel, simple, news, and CNN iReport, then at least one transition per theme is provided in the list of available transitions.

In the example of FIG. 4, a theme is already selected and applied to the video sequence. Therefore, the list 425 of available transitions includes generic transitions 430 as well as theme related transitions 435. The figure also shows that a transition 440 from the list 425 of available transitions is selected and is being manually placed between clips 405 and 410 (e.g., by a drag and drop operation on a touchscreen or by using a selection device such as a mouse).

Once a graphical element such as a title or transition is added to a video project, sound effects can be added to the graphical element to further enhance the video project. In the past a person using a media editing application had to manually select an audio file (e.g., from a library or by importing an audio file) and spot the audio file to the movie. In addition, the audio file had to be manually retimed, trimmed, faded in and out to properly fit in the video clip sequence of the movie. The volume of the audio file also had to be adjusted to blend with volume of the surrounding content in the video sequence.

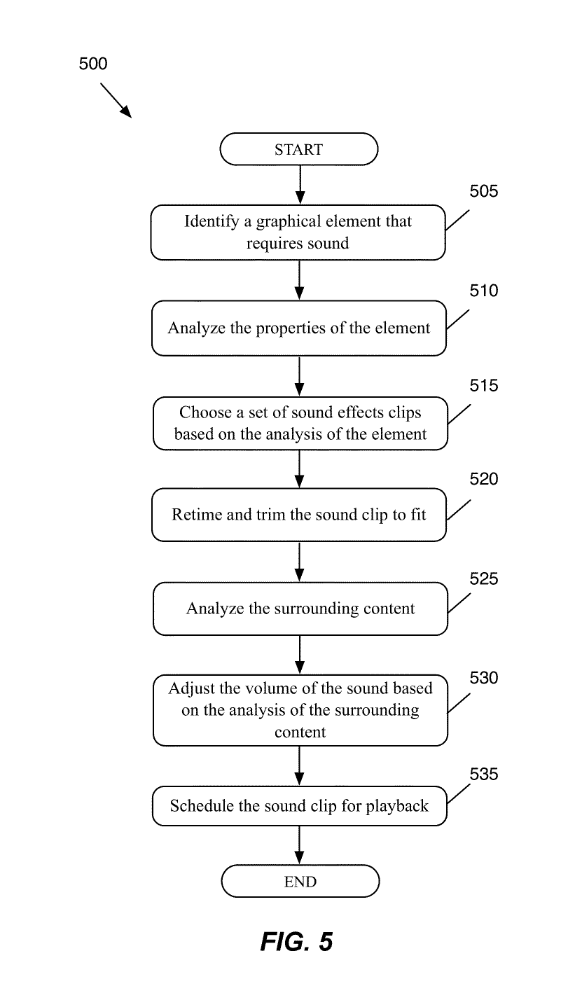

Some embodiments provide an automatic method of selecting, adding, and adjusting sound effects to graphical elements of a video sequence without requiring user intervention. FIG. 5 conceptually illustrates a process 500 for automatically adding sound effects to graphical elements such as transitions and titles in a sequence of video clips in some embodiments of the invention. As shown, the process identifies (at 505) a graphical element such as a transition or a title in a video sequence. For instance, the process identifies that transition 440 in FIG. 4 has been added to a sequence of video clips in a movie.

The process then analyzes (at 510) the properties of the added element. The process determines different properties of the graphical element such as type (e.g., transition or title), style (e.g., spin out transition, sport theme transition, news theme title, filmstrip theme title, etc.), and duration. The process also determines whether there is fade-in and fade-out and what are the durations of the fade-in and fade-out. In some embodiments, the graphical elements include metadata that describes different properties of the element. In these embodiments, process 500 also utilizes the metadata to determine the properties of a graphical element.

The process then chooses (at 515) a set of sound clips to apply to the graphical element based of the analysis of the properties of the element. Some embodiments, maintain one or more sound effects for each graphical element that is provided by the media editing application. For instance, for each title in the list 235 of titles shown in FIG. 2 and for each transition in the list 425 of transitions shown in FIG. 4 at least one set of sound effects are provided. In some embodiments, the sound effects are stored as media files.

In some of these embodiments, process 500 performs a table look up to identify a set of sound effects to apply to a graphical element. Depending on the type, duration, and other properties of the graphical element, the selected set of sound clips can have one or more sound clips. For instance, the set of selected sound effects for a particular title might have one sound clip for the coming-in period and one sound clip for the going out period while the selected set of sound clips for another title might only have one sound clip.

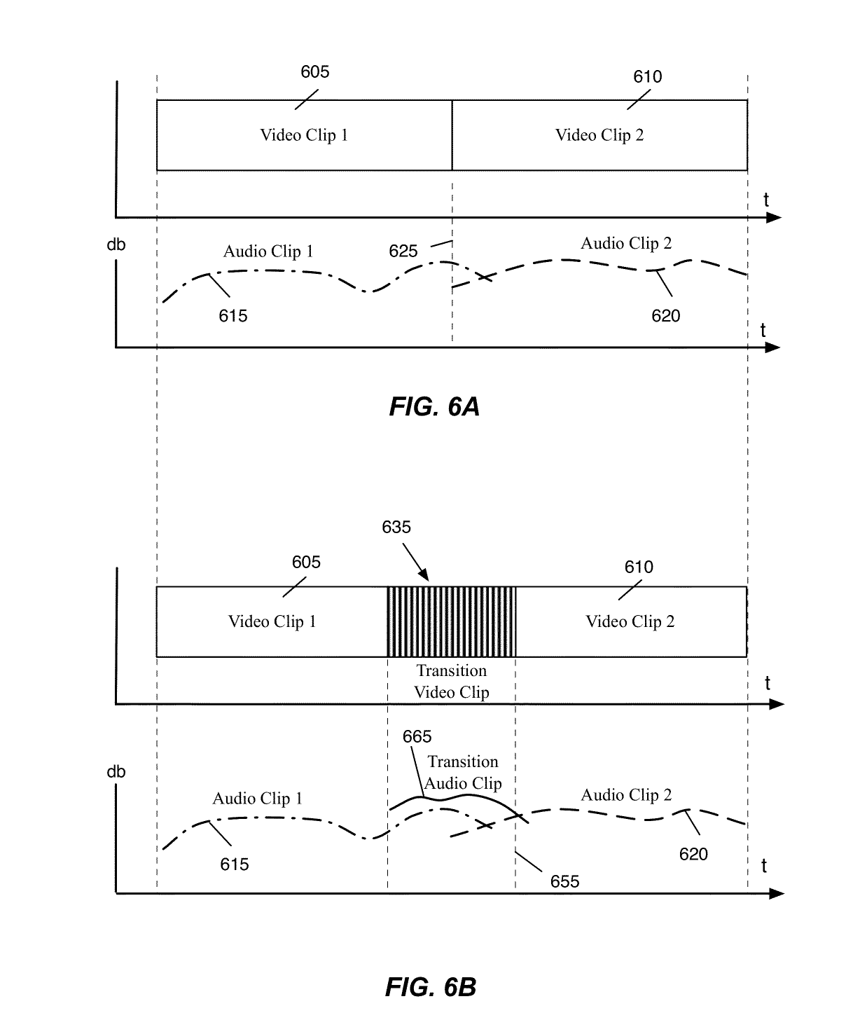

FIGS. 6A and 6B conceptually illustrate automatic application of a sound effects clip to a graphical element in some embodiments of the invention. FIG. 6A shows a portion of a video sequence that includes two video clips 605 and 610. The video clips 605 and 610 have the associated audio clips 615 and 620, respectively. For clarity, the figure shows the video and audio clips on separate timelines (t). The timeline for the video clips show that video clip 610 starts (as shown by the dashed line 625) after video clip 605 ends. The audio clips are shown as a graph of audio volume in decibels (db) versus time, t.

FIG. 6B shows the same video clips after a transition video clip 635 (e.g., transition 440 in FIG. 4) is added between the two video clips 605 and 610. As shown, process 500 has automatically selected an audio clip 665 based on the analysis of the added graphical element (i.e., transition video clip 635).

Referring back to FIG. 5, process 500 performs the sound effects selection by, for example, performing a table look up into a table that maps graphical elements (such as transition 635) to one or more sound effects (such as transition audio clip 665).

The process then retimes and trims (at 520) the sound clip to fit. For instance, the duration of the sound effects clip associated with a graphical element can be longer than the duration of the graphical element in order to allow the “tail” portion of the sound effects clip (e.g., the portion after the dashed line 655 shown in FIG. 6B) to be extended into the next audio clip. In the example of FIG. 6B, the tail portion of the transition audio 665 is trimmed and/or faded in order to blend with the audio clip 620.

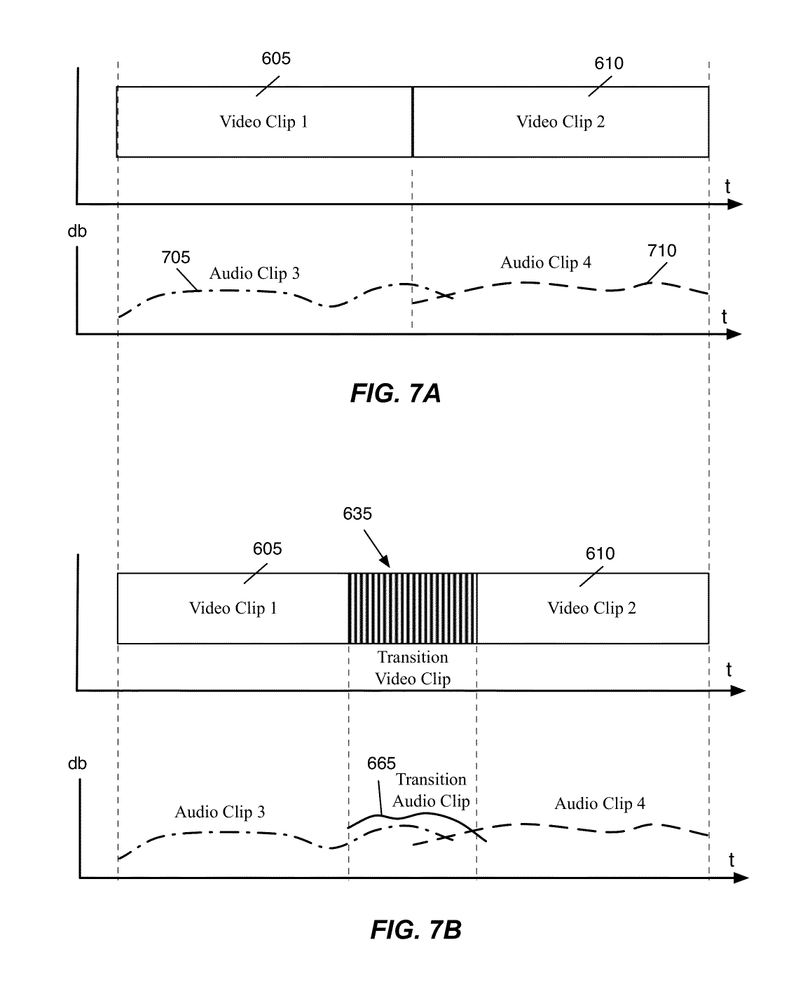

Process 500 then analyzes (at 525) the surrounding content. The process then adjusts (at 530) the volume of the added sound effects based on the analysis of the surrounding content. FIGS. 7A and 7B conceptually illustrate automatic application of a sound effects clip to the same graphical element as in FIGS. 6A and 6B when the surrounding content has a lower audio volume. As shown in FIG. 7A, the two video clips 605 and 610 have associated audio clips 705 and 710, respectively. Audio clips 705 and 710, however, have lower volumes than audio clips 615 and 620. For instance, either audio clips 705 and 710 were recorded with a lower volume or the volume of audio clips 615 and 620 is manually lowered by a person using the media editing application to create audio clips 705 and 710.

As shown in FIG. 7B, process 500 has selected the same sound effects clip 665 as in FIG. 6B. Process 500 has, however, automatically adjusted the volume of sound effects audio clip 665 after analyzing the surrounding content. Analysis of the surrounding content includes considering the audio volume of audio clips, before and/or after the sound effects audio clip 665, considering the average volume of all audio in the movie, the theme of the video sequence, etc. Process 500 then schedules (at 535) the added sound clip for playback. The process then ends. In some embodiments, process 500 is launched after a new graphical element such as a transition or a title is added to a video sequence and an option to automatically add sound effects clips to graphical elements is turned on. Once process 500 is launched, the process performs operations 505-535 without receiving any human inputs or other human interventions. A user of the media editing application, therefore, does not have to manually select, adjust, or spot audio effects for the graphical element.

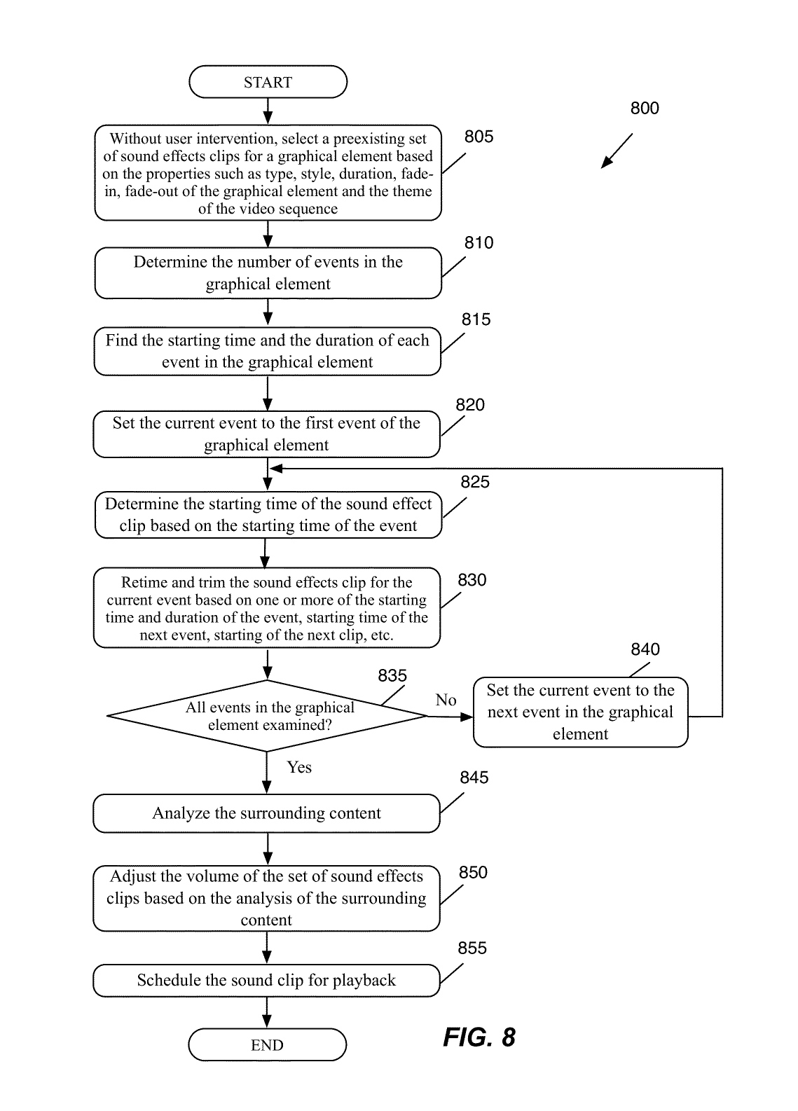

FIG. 8 conceptually illustrates a process 800 and provides further details for automatically adding sound effects to graphical elements in some embodiments of the invention. The process, without user intervention, selects (at 805) a preexisting set of sound effects clips for a graphical element based on the properties such as style, duration, fade-in, fade-out of the graphical element and the theme (if any) of the vide sequence. The process, for instance, performs a table look up to identify one or more sets or sound effects media files associated with the graphical element.

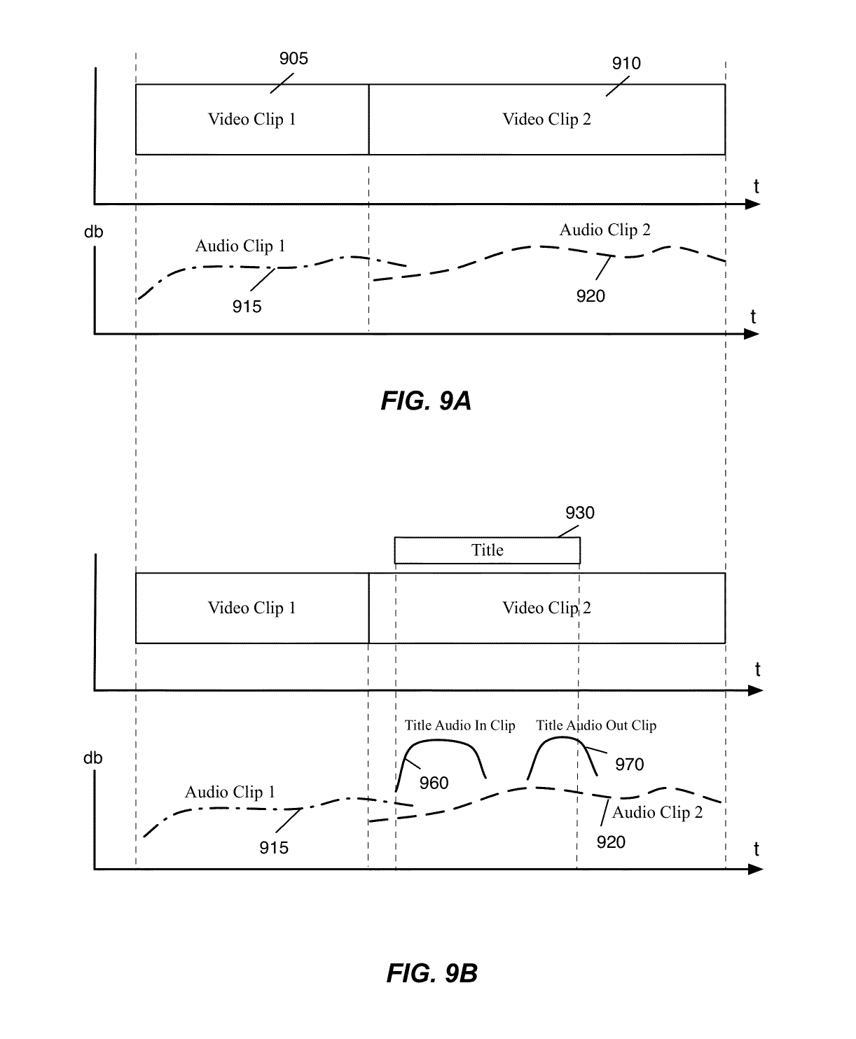

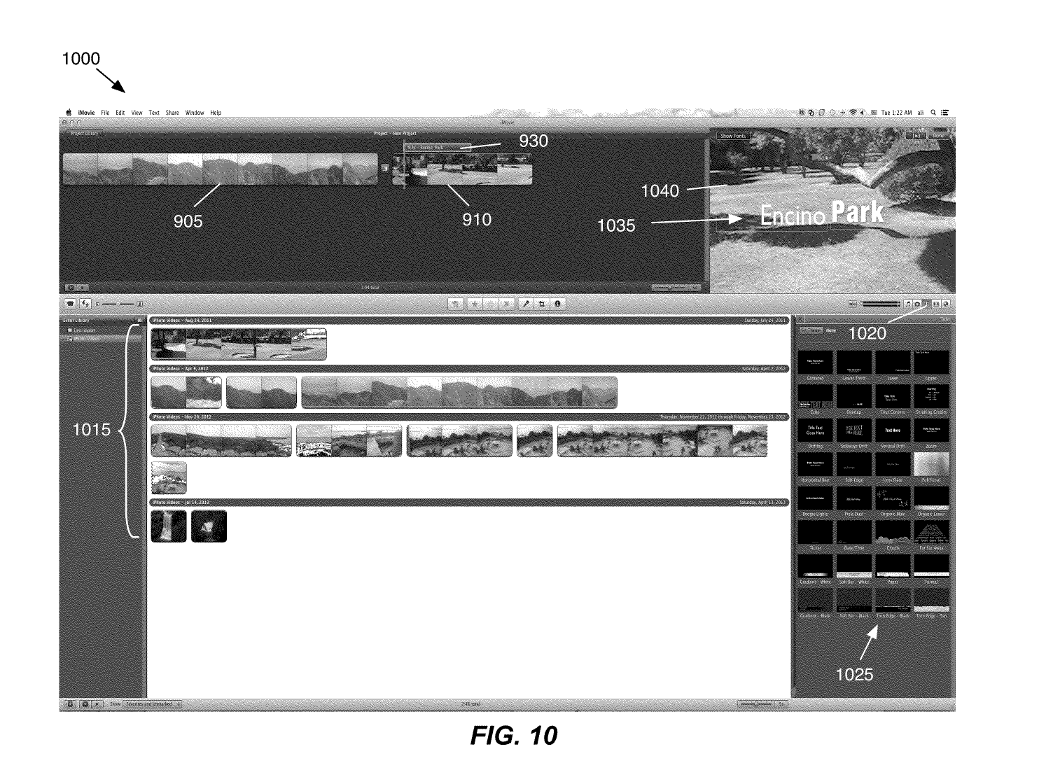

A set of sound effects can have one or more audio clips. For instance, the set of sound effects selected for transition video clip 635 in FIGS. 6B and 7B had one audio clip 665. FIGS. 9A and 9B conceptually illustrate automatic application of a set of sound effects that include more than one sound clip to a graphical element in some embodiments of the invention. FIG. 9A shows a portion of a video sequence that includes two video clips 905 and 910. The video clips 905 and 910 have the associated audio clips 915 and 920, respectively. In FIG. 9B, a title 930 is added to video clip 910. FIG. 10 illustrates a user interface 1000 used to add a title to a video sequence in some embodiments of the invention. As shown in FIG. 10, video clips 905 and 910 are selected from a library 1015 of video clips to create a video sequence. A control 1020 is activated to display a list 1025 of available titles to add to the sequence of video clips.

Examples of available titles are standard, prism, gravity, reveal, line, expand, focus, pop-up, drafting, sideways draft, vertical draft, horizontal blur, soft edge, lens flare, pull force, boogie lights, pixie dust, organic main organic lower, ticker, data/time, clouds, far far away, gradient white, soft blur white paper, formal, gradient black, soft blur black, torn edge black, torn edge tan, etc. In addition, some embodiments provide at least one title for each theme. For instance, if the available themes are modern, bright, playful, neon, travel, simple, news, and CNN iReport, then at least one title per theme is provided in the list of available titles. In the example of FIG. 10, a theme is not selected for the video sequence. Therefore, the list 1025 of available titles does not include any theme related titles.

FIG. 10 also shows that a title from the list 1025 of available transitions is selected and is added to video clip 910 as graphically shown by the rectangle 930. A title can be added to start from anywhere on a video clip. The title is displayed (as shown by the arrow 1035) on the video clip that is being monitored on the monitoring area 1040. As shown in FIG. 9B, the set of sound effects for title 930 includes two sound clips: a sound clip 960 to apply to the title as the title starts being displayed in the movie and a sound clip 970 to apply to the title as the title is being removed from the movie. In general, a graphical element can have any number of events (or sub elements). In some embodiments, each event (or sub element) in the graphical element can have a corresponding sound effects clip. In the example of FIG. 9B, the title 930 has two events (coming in and going out) with the corresponding sound clips 960 and 970.

Examples of events (or sub elements) of a graphical element include any animations such as an image in a title or transition zooming in or zooming out; a scene fading in or fading out; a message popping out; text added to the screen as if being typed; any animations such as swap, cut, page curl, fade, spin out, mosaic, ripple, blur, dissolve, wipe, credits start scrolling, etc.

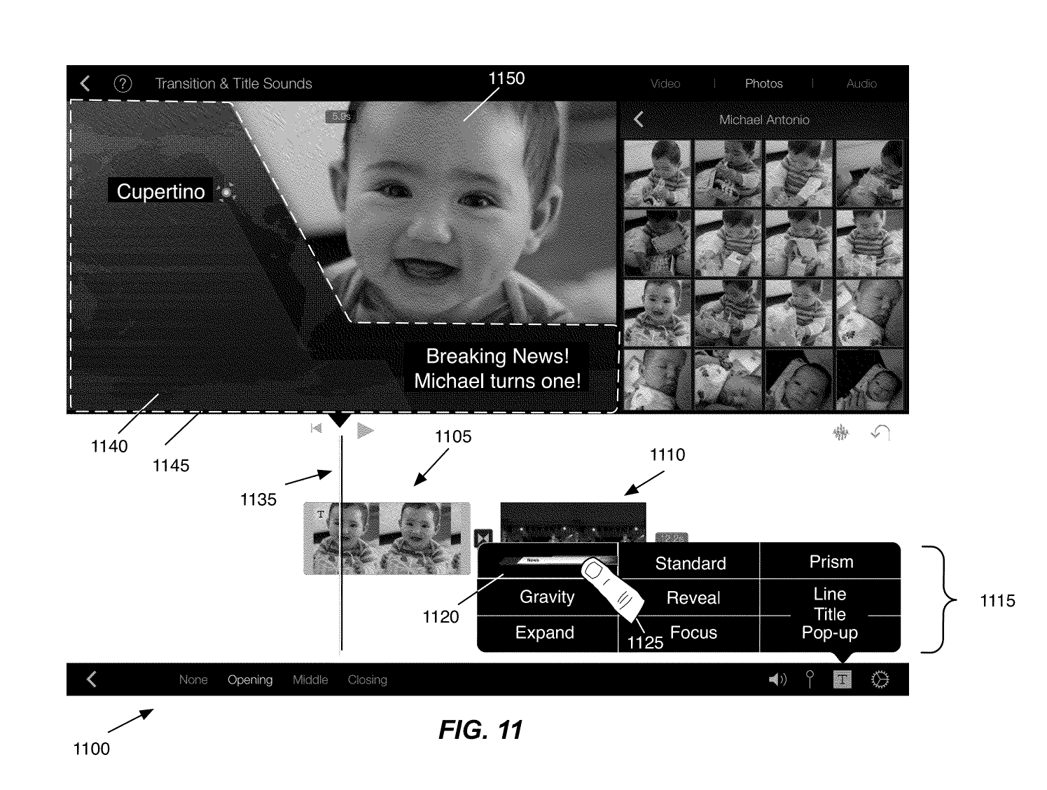

FIG. 11 illustrates another example of a user interface 1100 used to add a title to a video sequence in some embodiments of the invention. As shown, a project that includes two video clips 1105 and 1110 is created. In addition, a list 1115 of available title styles is displayed. The list includes standard, prism, gravity, reveal, line title, expand, focus, and pop-up styles. Each of these title styles has a particular look and animation. In the example of FIG. 11, a news theme has previously been applied to the project. As shown, a news theme related title 1120 is also provided in the list 1115 of the available titles.

In the example of FIG. 11, the news theme related title 1120 is selected (as conceptually shown by a finger 1125 touching the title 1120 in the list 1115 of available titles). In this example, the play head 1135 is over a portion of video clip 1105 to which the title is applied. As shown, the title (conceptually delineated by dashed box 1145) is played over a portion 1150 of the video clip 1105 that is being played in the preview display area 1140.

Referring back to FIG. 8, process 800 determines (at 810) the number of events in the graphical element. For instance, the graphical element in the example of FIG. 6B, is a transition 635 that has only one event (e.g., swap, spin out, fade to white, etc.). The set of sound effects clips for this graphical element has one sound clip 665. On the other hand, the graphical element in the example of FIG. 9B is a title 930 that has two events (e.g., coming in, going out). The set of sound effects clips for this graphical element has two sound clip 960 and 970.

Process 800 then finds (at 815) the starting time and the duration of each event in the graphical element. The process then sets (at 820) the current event to the first event of the graphical element. The process then determines the starting time of the sound effects clip for the current event based on the starting time of the event. The process in some embodiments also considers other properties of the graphical element such as the duration of the event in order to determine the starting time of the sound effects clip. For instance, if the duration of an event is too short, some embodiments do not add the sound effects clip for the event.

The process also retimes and/or trims (at 830) the sound effects clip for the current event of the graphical element based on the starting time and duration of the event, starting time of the next event, starting time and the duration (or ending time) of the graphical element, starting time of the next clip, etc. The process then determines (at 835) whether all events in the graphical element are examined. If yes, the process proceeds to 845, which is described below. Otherwise, the process sets (at 840) the current event to the next event in the graphical element. The process then proceeds to 825, which was described above.

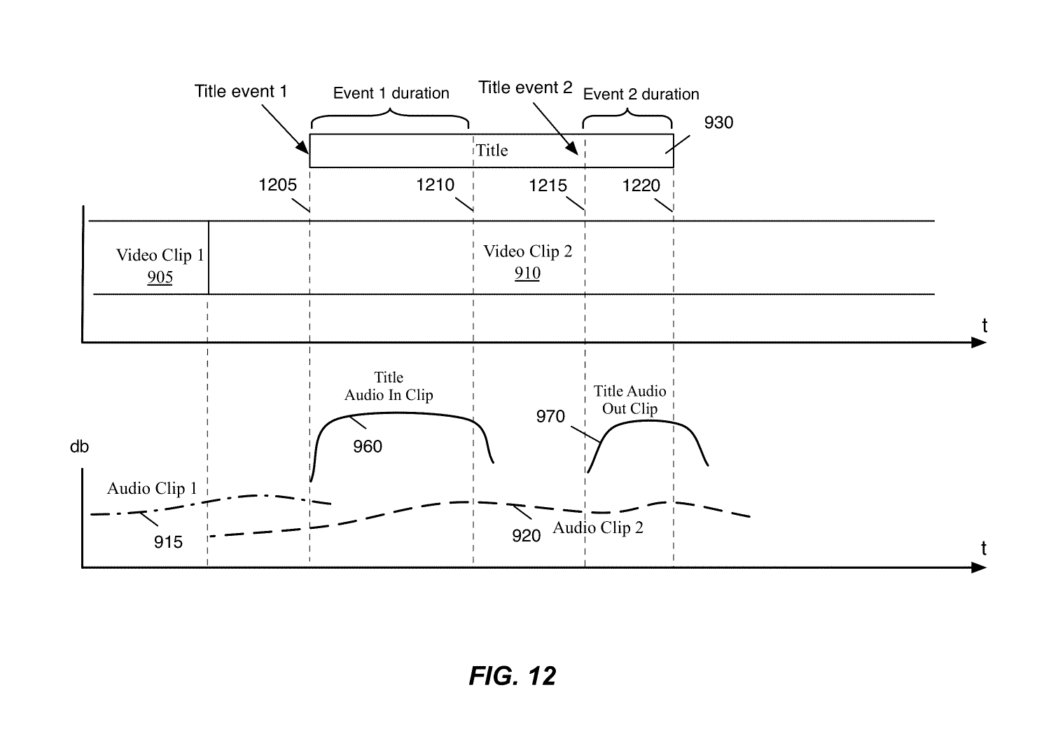

FIG. 12 conceptually illustrates the graphical element and the corresponding sound effects clips of FIG. 9 in more details. As shown, title 930 has two events. The first event starts when the title is just being displayed (as shown by the dashed line 1205). The second event starts while the title is being displayed (as shown by the dashed lime 1210). These events can correspond to different properties of the title such as the title being animated in and animated out; the title being faded in or faded out; the title being displayed in a first color and a second color; the title has a first scene and a second scene; etc. In general, a graphical element can have an arbitrary number of events associated to it (e.g., having n different scenes, where n is greater than or equal to one).

Process 800 determines (at 815 described above) the starting time and duration of each event for a graphical element. For instance, process 800 determines the starting time of the first event (starting at dashed line 1205), the duration of the first event (between dashed lines 1205 and 1210), the starting time of the second event (starting at dashed line 1215), the duration of the second event (between dashed lines 1215 and 1220), starting time of the next clip (not shown). In some embodiments, process 800 finds the time and duration of the events by analyzing the properties of the graphical element 930. For instance, the process analyzes the metadata associated with the graphical element or performs a table look up to find the properties of each graphical element (e.g., based on the type and style of the graphical element, the theme of the video sequence, etc.).

The process then spots the audio clips (at 825 described above) to the proper location of the video sequence (i.e., determines where each audio clip has to start). The process optionally trims or fades (at 830 described above) each audio clip based on the duration of the event, starting time of the next event, the starting time of the next clip, etc. For instance, a portion of a sound clip for an event may continue after the end of the event. In the example of FIG. 12, both sound effects clips 960 and 970 continue for a period of time after the end of their corresponding events (as shown each sound effects clip continue after the end of the corresponding events shown by dashed lines 1210 and 1220).

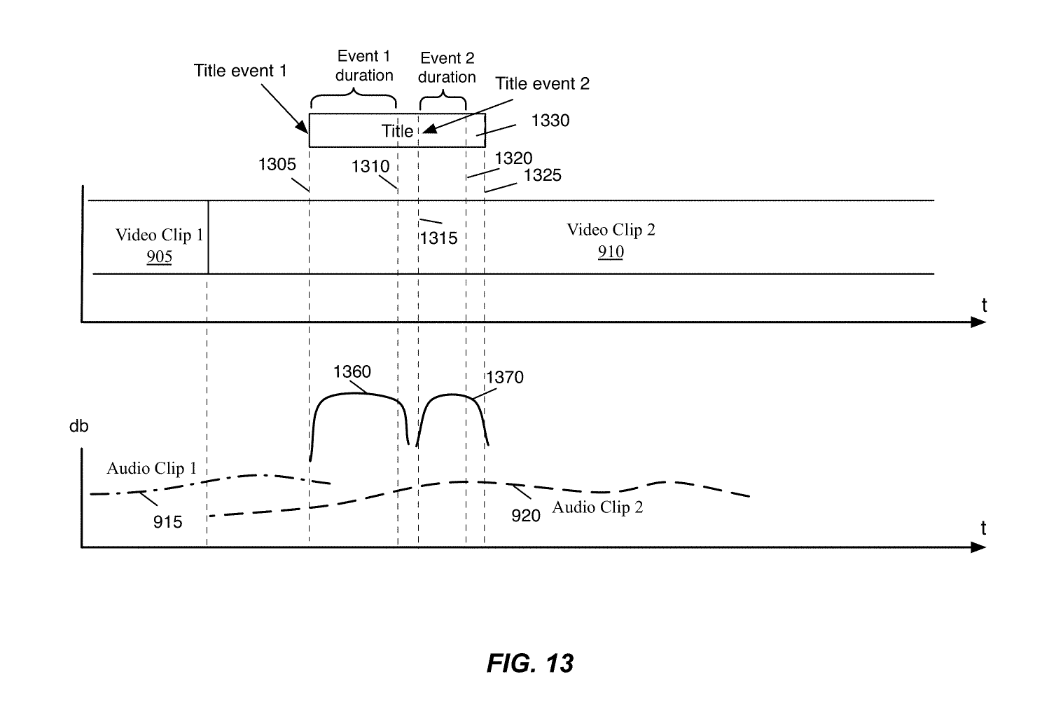

FIG. 13 conceptually illustrates the video clips of FIGS. 9 and 12 when a different graphical element is added to the second video clip. As shown in FIG. 13, the added graphical element 1330 is a title that is shorter than (as shown by dashed lines 1305 and 1325) the title 930 in FIGS. 9 and 12. In addition, the second event starts closer to the end of the first event (as shown by dashed lines 1310 and 1315) and ends closer to the end of the graphical element (as shown by dashed lines 1320 and 1325) than the second event in FIG. 12. As shown, process 800 retimes and trims the audio clips 1360 and 1370 to fit the graphical element (e.g., by shortening the durations and fading out the clips sooner to avoid clip 1360 to overlap clip 1370 and to avoid clip 1370 to go too much beyond the end of the graphical element 1330.

Referring back to FIG. 8, the process then analyzes (at 845) the surrounding content. The process then adjusts (at 850) the volume of the set of sound effects clips based on the analysis of the surrounding content (e.g., as described above by reference to FIGS. 7A and 7B). The process then schedules (at 855) the sound clip for playback. The process then ends. In some embodiments, process 800 is launched after a new graphical element such as a transition or a title is added to a video sequence and an option to automatically add sound effects clips to graphical elements is turned on. Once process 800 is launched, the process performs operations 805-855 without receiving any human inputs or other human interventions. A user of the media editing application, therefore, does not have to manually select, adjust, or spot audio effects for the graphical element.

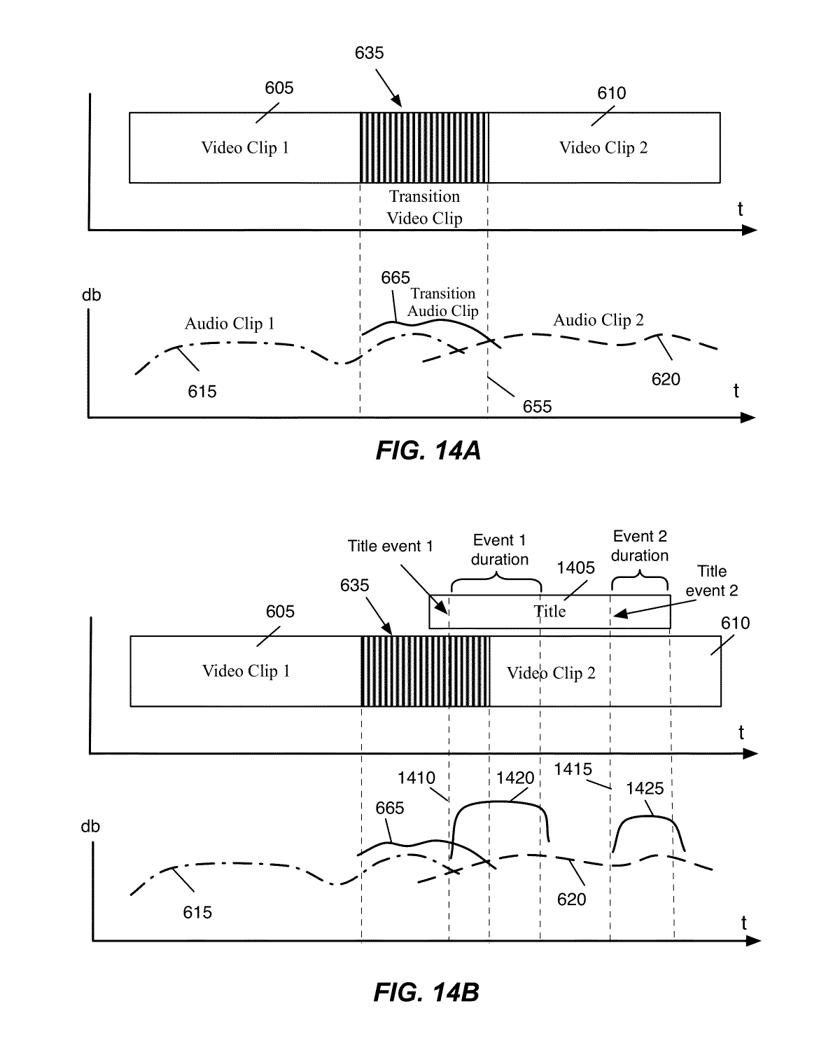

Some embodiments allow several graphical elements to overlap each other or added in vicinity of each other. Different embodiments provide sound effects for these overlapping or nearby graphical elements differently. For instance, some embodiments overlap the corresponding sound effects clips after retiming, trimming, and/or fading one or more of the sound effects clips. Yet other embodiments favor one sound effects clip over the others. FIGS. 14A and 14B conceptually illustrates an example of adding sound effects to overlapping graphical elements in some embodiments of the invention. FIG. 14A is similar to FIG. 6B where a transition 635 is added between two video clips 605 and 610. The video clips 605 and 610 have the corresponding audio clips 615 and 620. A sound effects clip 665 is added for the transition video.

In FIG. 14B, another graphical element 1405 is added to the video sequence. As shown, the graphical element 1405 is a title that overlaps the transition 635 and video clip 610. In this example, the title 1405 has two events as marked by dashed lines 1410 and 1415. The two sound effects audio clips 1420 and 1425 are automatically (e.g., by launching process 500 or 800) selected, trimmed, and/or faded and added to the movie. In this example, sound effects audio clip 1420 overlaps sound effects audio clip 665 that corresponds to transition video 635.

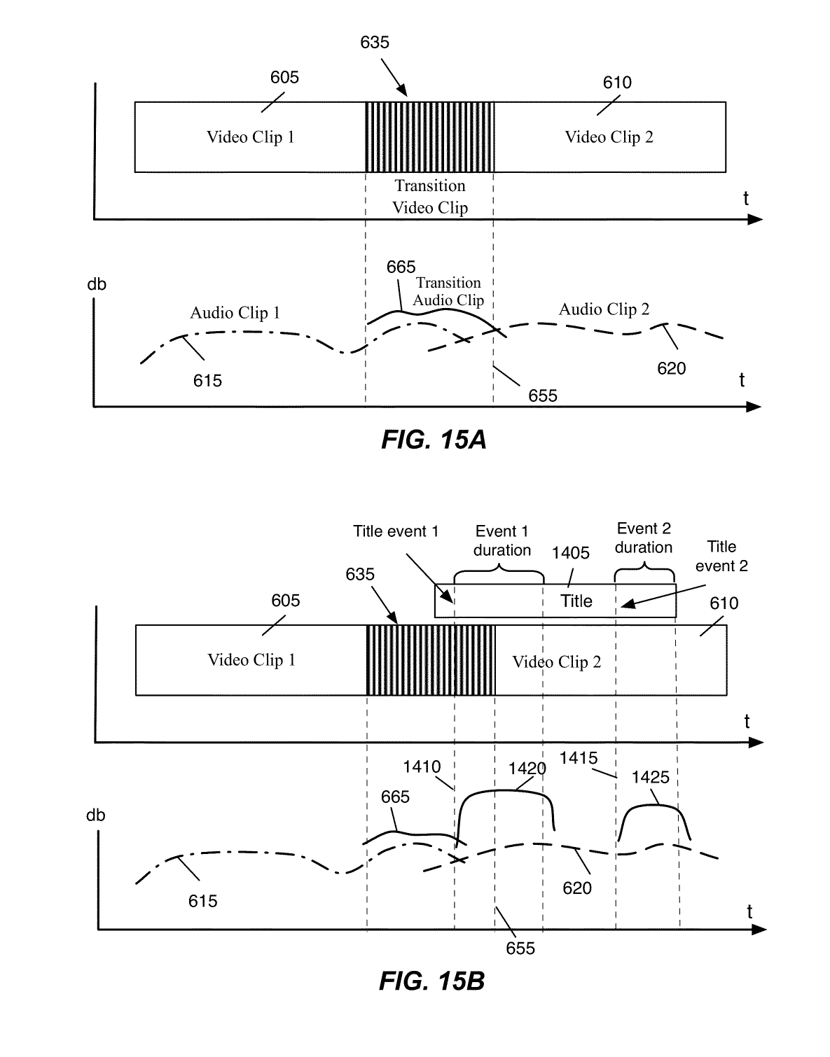

FIGS. 15A and 15B conceptually illustrate another example of adding sound effects to overlapping graphical elements in some embodiments of the invention. FIG. 15A is similar to FIG. 14A where a transition 635 is added between two video clips 605 and 610. The video clips 605 and 610 have the corresponding audio clips 615 and 620. A sound effects clip 665 is added for the transition video. FIG. 15B is also similar to FIG. 14B in that a title 1405 and two corresponding sound effects audio clips 1420 and 1425 are added to the movie. In FIG. 14B, however, sound effects audio clip 665 is trimmed and faded out, which is conceptually shown by the audio clip 665 in FIG. 15B not extended to the end of the transition video (marked by dashed line 655) and faded near the beginning of sound effects audio clip 1420.

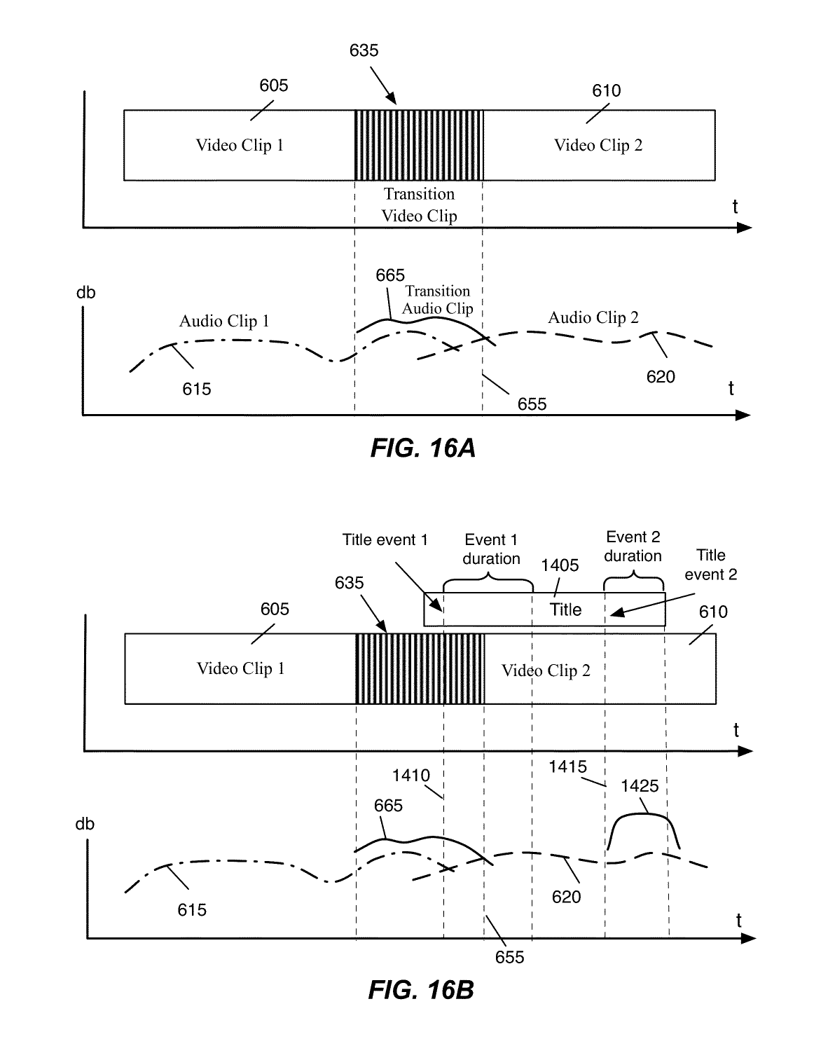

FIGS. 16A and 16B conceptually illustrate another example of adding sound effects to overlapping graphical elements in some embodiments of the invention. FIGS. 16A and 16B are similar to FIGS. 14A-14B and 15A-15B, except in FIG. 16B one of the two sound effects audio clips that corresponds to the first event of the title 1405 is not added to the movie. In the example of FIG. 16B, sound effects audio clip 1420 (which was added in FIGS. 14B and 15B) is not added to the movie in favor of sound effects audio clip 665 of the transition video 665. Different embodiments use different criteria to eliminate one or more of the sound effects audio clips. For instance, some embodiments give priorities to overlapping or nearby graphical elements based on their type, style, duration, starting time, or other properties and trim or delete one or more of the sound effects clips based on the priority of their associated graphical element.

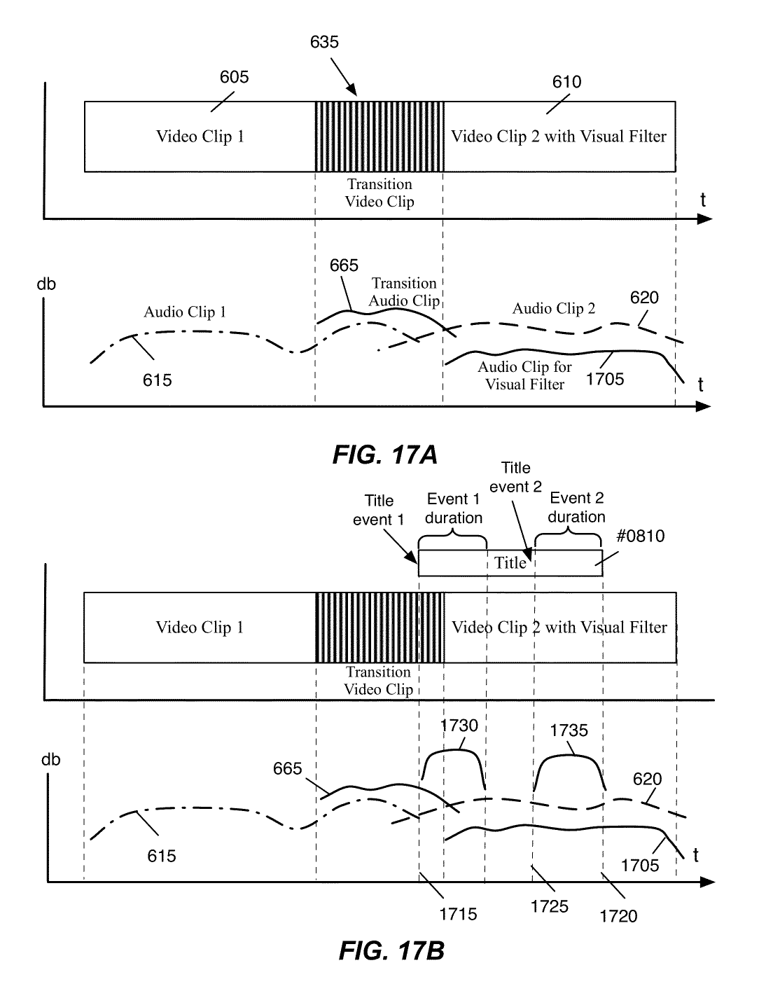

FIGS. 17A and 17B conceptually illustrate another example of adding sound effects to overlapping graphical elements in some embodiments of the invention. As shown in FIG. 17A, the video sequence in the movie includes two video clips 605 and 610 and their corresponding audio clips 615 and 620. The video sequence also has a transition 635 and the corresponding sound effects audio clip 665. In addition, a visual audio filter is applied to the video clip 610 (e.g., by a person creating or editing the movie). Visual filters are applied to still images and video clips to modify their appearance and create visual effects. Examples of video effects include dream, sepia, negative, and x-ray.

As shown in FIG. 17A, an audio clip 1705 corresponding to the visual filter is also automatically added (e.g., by launching process 500 or 800) to the movie. In FIG. 17B, a title 1710 is also added to the movie. The title is added to the transition as well as to the portion of the video clip with visual filter 610 (i.e., during a play back of the movie, the title will be displayed during the last portion of the transition 635 and the first portion of video clip 610 as shown by dashed lines 1715 and 1720.

The title has two events starting at dashed lines 1715 and 1725. As shown, two sound effects audio clips 1730 and 1735 corresponding to the two events are added to the movie. In this example, the two audio clips are trimmed, retimed, and/or faded to fit the movie (as described above by reference to FIG. 14B). Alternatively, one or more of the sound effects clips 665, 1730, 1735, and 1705 can be further trimmed or faded, for example as described above by reference to FIG. 15B. Also, one or more of the clips may be eliminated (i.e., not added to the movie), for example as described above by reference to FIG. 16B.

### II. Software Architecture

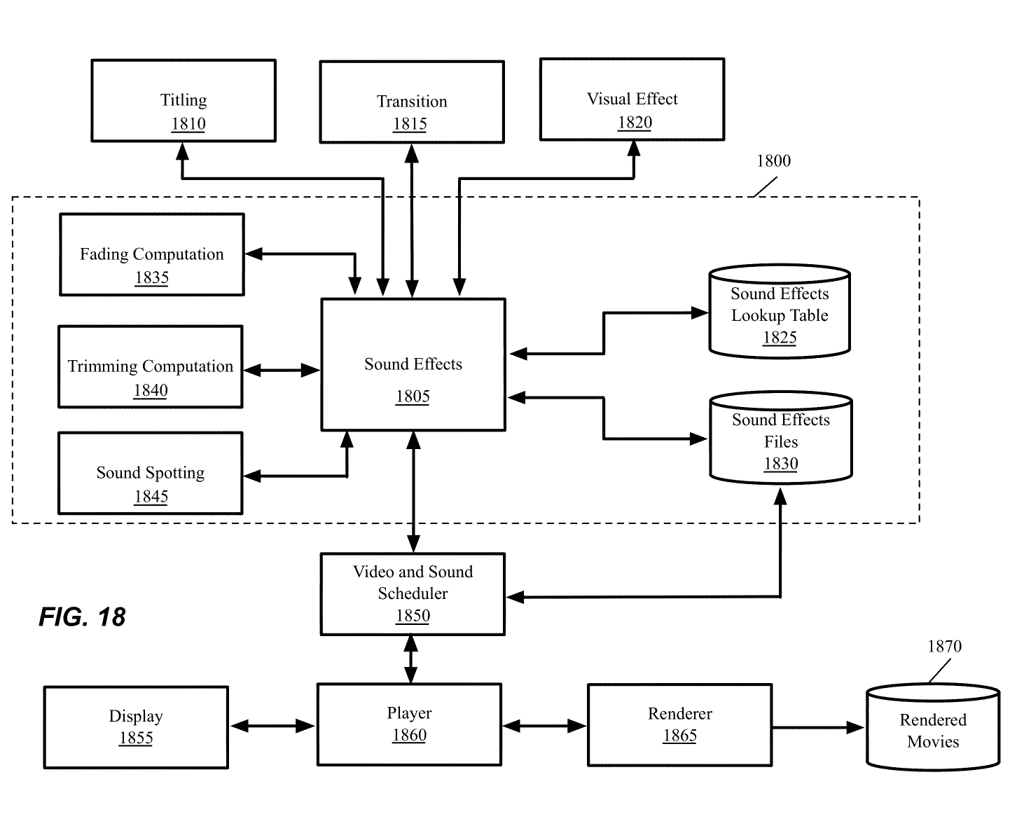

FIG. 18 conceptually illustrates the high-level software architecture for automatically adding sound effects to graphical elements in some embodiments of the invention. As shown, the automatic sound effects creation system 1800 includes the sound effects module 1805, fading computation module 1835, trimming computation module 1840, sound spotting module 1845, sound effects lookup table 1825, and a set of sound effects media files 1830.

The sound effects module 1805 communicates with titling module 1810, transition module 1815, and visual effect module 1820 to get information about the added graphical elements such as titles, transitions, visual filters, etc.

The sound effects module 1805 performs lookups into sound effects lookup table 1825 to find a set of sound effects clips for each graphical element. The sound effects module 1805 analyzes properties of each graphical element. Based on the properties of each graphical element, sound effects module 1805 selects a set of sound effects clips from sound effects files database 1830.

The sound effects module 1805 utilizes fading computation module 1835, trimming computation module 1840, and/or sound spotting module 1845 to perform fading, trimming, and spotting operations for the sound clip. The sound effects module 1805 stores the resulting sound effects and informs the video and sound scheduler module 1850 to schedule the added sound effects clips for playback.

The video and sound scheduler module 1850 schedules the video and audio clips including the sound effects clips during playback and monitoring and sends the clips to player 1860 to display on a display screen 1855. The player optionally sends the video and audio clips to renderer module 1865. The renderer module generates a sequence of video and audio clips and saves the sequence in rendered movies database 1870, for example to burn into storage media such as DVDs, Blu-Ray® discs, etc.

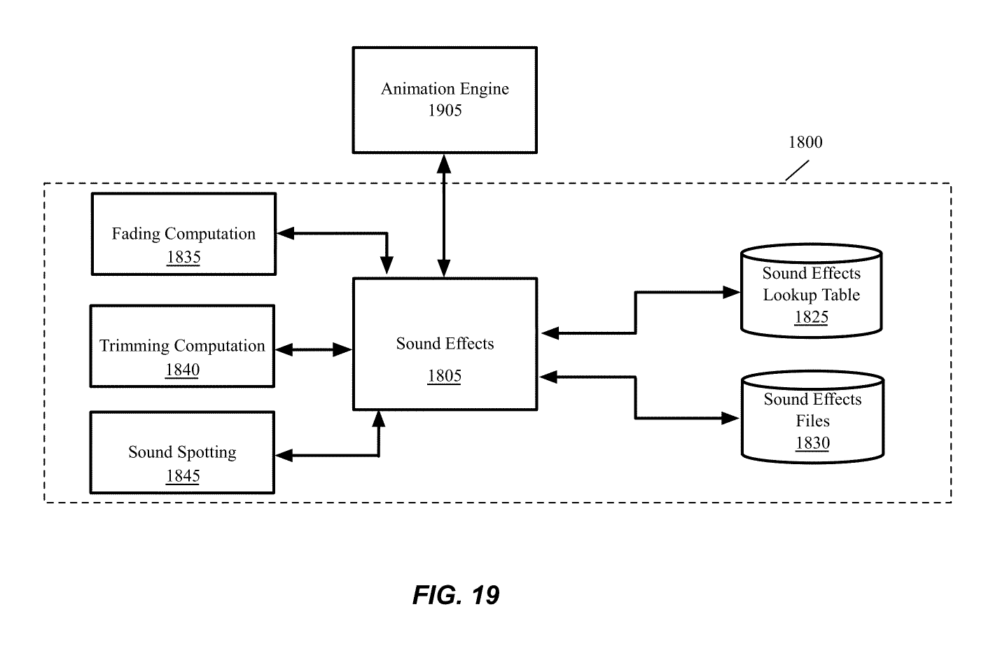

In some embodiments, titling module 1810, transition module 1815, and visual effect module 1820 are part of a media editing applications. In other embodiments, these modules are part of an animation engine that animates still images or video images and requires sound effects to be applied to visual elements. FIG. 19 conceptually illustrates the high-level software architecture for automatically adding sound effects to graphical elements generated by an animation engine in some embodiments of the invention.

As shown, the automatic sound effects creation system 1800 is similar to the automatic sound effects creation system described by reference to FIG. 18 and includes the sound effects module 1805, fading computation module 1835, trimming computation module 1840, sound spotting module 1845, sound effects lookup table 1825, and a set of sound effects files 1830.

The animation engine 1905 is any application that creates still image and/or video image animation and requires sound effects for the animations. Examples of animations include but is not limited to zoom in, zoom out, fade in, fades out, messages popping out, text added to an image, swap, cut, page curl, spin out, mosaic, ripple, blur, dissolve, wipe, text start or stop scrolling, etc.

The animation engine 1905 provides the properties of the animation (e.g., type, style, duration, number of events, etc.) of visual elements to the sound effects module 1805. The sound effects module 1805 performs lookups into sound effects lookup table 1825 to find a set of sound effects clips for each visual element. The sound effects module 1805 analyzes properties of each visual element. Based on the properties of each visual element, sound effects module 1805 selects a set of sound effects clips from sound effects files database 1830.

The sound effects module 1805 utilizes fading computation module 1835, trimming computation module 1840, and/or sound spotting module 1845 to perform fading, trimming, and spotting operations for the sound clip. The sound effects module 1805 sends the sound effects clips to the animation engine 1905 and optionally stores the clips in the sound effects files database 1830.

### III. Electronic System

Many of the above-described features and applications are implemented as software processes that are specified as a set of instructions recorded on a computer readable storage medium (also referred to as computer readable medium, machine readable medium, machine readable storage). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

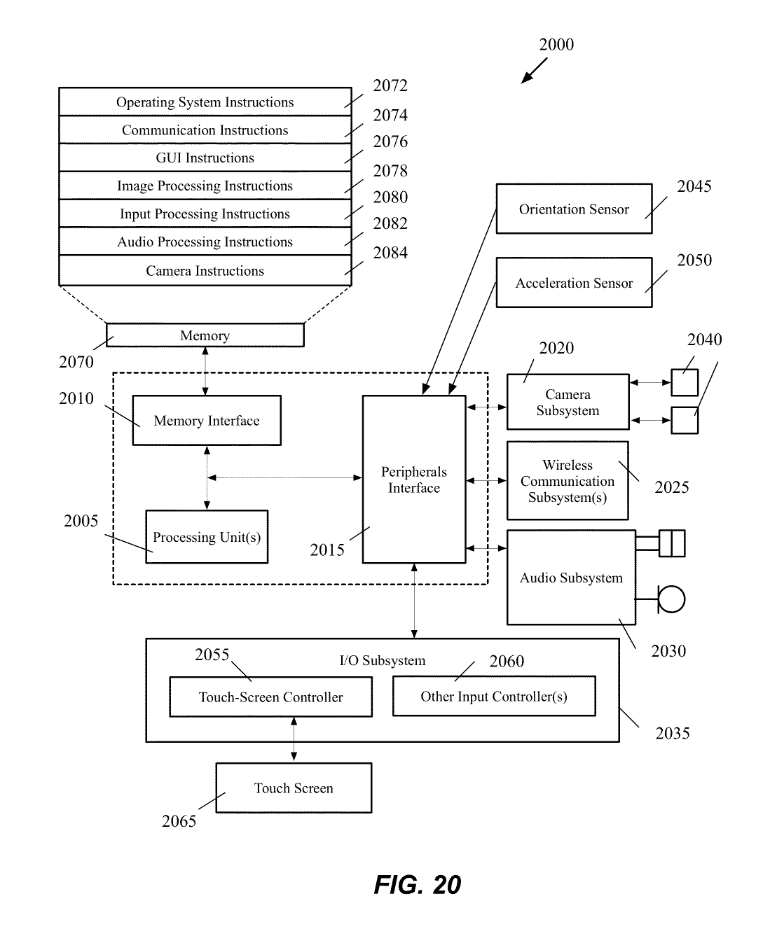

The automatic custom sound effects adding in some embodiments operates on mobile devices, such as smart phones (e.g., iPhones®) and tablets (e.g., iPads®). FIG. 20 is an example of an architecture 2000 of such a mobile computing device. Examples of mobile computing devices include smartphones, tablets, laptops, etc. As shown, the mobile computing device 2000 includes one or more processing units 2005, a memory interface 2010 and a peripherals interface 2015.

The peripherals interface 2015 is coupled to various sensors and subsystems, including a camera subsystem 2020, a wireless communication subsystem(s) 2025, an audio subsystem 2030, an I/O subsystem 2035, etc. The peripherals interface 2015 enables communication between the processing units 2005 and various peripherals. For example, an orientation sensor 2045 (e.g., a gyroscope) and an acceleration sensor 2050 (e.g., an accelerometer) is coupled to the peripherals interface 2015 to facilitate orientation and acceleration functions.

The camera subsystem 2020 is coupled to one or more optical sensors 2040 (e.g., a charged coupled device (CCD) optical sensor, a complementary metal-oxide-semiconductor (CMOS) optical sensor, etc.). The camera subsystem 2020 coupled with the optical sensors 2040 facilitates camera functions, such as image and/or video data capturing. The wireless communication subsystem 2025 serves to facilitate communication functions. In some embodiments, the wireless communication subsystem 2025 includes radio frequency receivers and transmitters, and optical receivers and transmitters (not shown in FIG. 20). These receivers and transmitters of some embodiments are implemented to operate over one or more communication networks such as a GSM network, a Wi-Fi network, a Bluetooth network, etc. The audio subsystem 2030 is coupled to a speaker to output audio (e.g., to output voice navigation instructions). Additionally, the audio subsystem 2030 is coupled to a microphone to facilitate voice-enabled functions, such as voice recognition (e.g., for searching), digital recording, etc.

The I/O subsystem 2035 involves the transfer between input/output peripheral devices, such as a display, a touch screen, etc., and the data bus of the processing units 2005 through the peripherals interface 2015. The I/O subsystem 2035 includes a touch-screen controller 2055 and other input controllers 2060 to facilitate the transfer between input/output peripheral devices and the data bus of the processing units 2005. As shown, the touch-screen controller 2055 is coupled to a touch screen 2065. The touch-screen controller 2055 detects contact and movement on the touch screen 2065 using any of multiple touch sensitivity technologies. The other input controllers 2060 are coupled to other input/control devices, such as one or more buttons. Some embodiments include a near-touch sensitive screen and a corresponding controller that can detect near-touch interactions instead of or in addition to touch interactions.

The memory interface 2010 is coupled to memory 2070. In some embodiments, the memory 2070 includes volatile memory (e.g., high-speed random access memory), non-volatile memory (e.g., flash memory), a combination of volatile and non-volatile memory, and/or any other type of memory. As illustrated in FIG. 20, the memory 2070 stores an operating system (OS) 2072. The OS 2072 includes instructions for handling basic system services and for performing hardware dependent tasks.

The memory 2070 also includes communication instructions 2074 to facilitate communicating with one or more additional devices; graphical user interface instructions 2076 to facilitate graphic user interface processing; image processing instructions 2078 to facilitate image-related processing and functions; input processing instructions 2080 to facilitate input-related (e.g., touch input) processes and functions; audio processing instructions 2082 to facilitate audio-related processes and functions; and camera instructions 2084 to facilitate camera-related processes and functions. The instructions described above are merely exemplary and the memory 2070 includes additional and/or other instructions in some embodiments. For instance, the memory for a smartphone may include phone instructions to facilitate phone-related processes and functions. Additionally, the memory may include instructions for automatic custom sound effects adding to graphical elements as well as instructions for other applications. The above-identified instructions need not be implemented as separate software programs or modules. Various functions of the mobile computing device can be implemented in hardware and/or in software, including in one or more signal processing and/or application specific integrated circuits.

While the components illustrated in FIG. 20 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 20 may be split into two or more integrated circuits.

B. Computer System

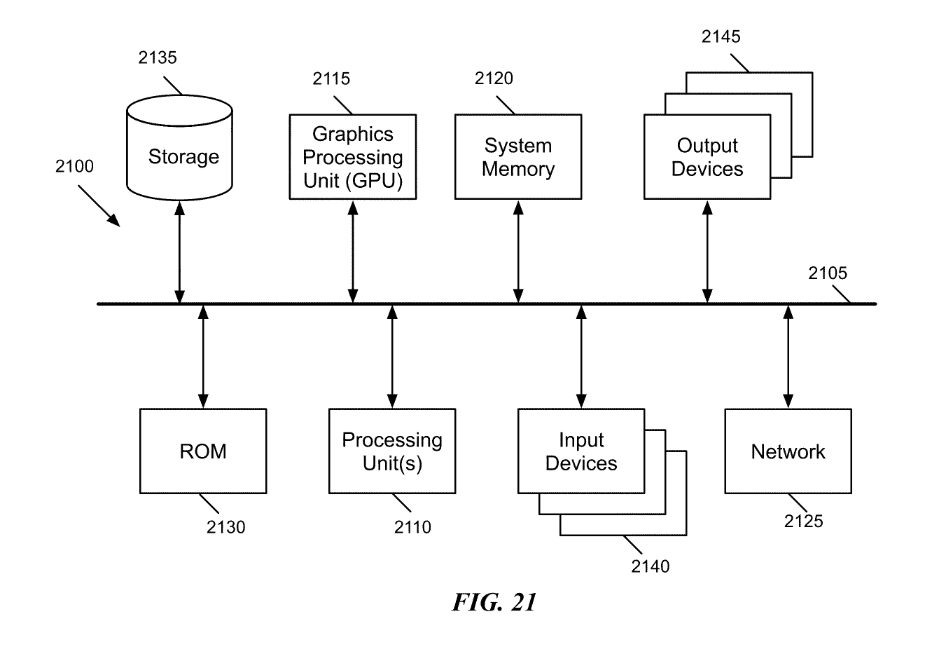

FIG. 21 conceptually illustrates another example of an electronic system 2100 with which some embodiments of the invention are implemented. The electronic system 2100 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 2100 includes a bus 2105, processing unit(s) 2110, a graphics processing unit (GPU) 2115, a system memory 2120, a network 2125, a read-only memory 2130, a permanent storage device 2135, input devices 2140, and output devices 2145.

The bus 2105 collectively represents all system, peripheral, and chipset buses that communicatively connect the numerous internal devices of the electronic system 2100. For instance, the bus 2105 communicatively connects the processing unit(s) 2110 with the read-only memory 2130, the GPU 2115, the system memory 2120, and the permanent storage device 2135.

From these various memory units, the processing unit(s) 2110 retrieves instructions to execute and data to process in order to execute the processes of the invention. The processing unit(s) may be a single processor or a multi-core processor in different embodiments. Some instructions are passed to and executed by the GPU 2115. The GPU 2115 can offload various computations or complement the image processing provided by the processing unit(s) 2110.

The read-only-memory (ROM) 2130 stores static data and instructions that are needed by the processing unit(s) 2110 and other modules of the electronic system. The permanent storage device 2135, on the other hand, is a read-and-write memory device. This device is a non-volatile memory unit that stores instructions and data even when the electronic system 2100 is off. Some embodiments of the invention use a mass-storage device (such as a magnetic or optical disk and its corresponding disk drive, integrated flash memory) as the permanent storage device 2135.

Other embodiments use a removable storage device (such as a floppy disk, flash memory device, etc., and its corresponding drive) as the permanent storage device. Like the permanent storage device 2135, the system memory 2120 is a read-and-write memory device. However, unlike storage device 2135, the system memory 2120 is a volatile read-and-write memory, such a random access memory. The system memory 2120 stores some of the instructions and data that the processor needs at runtime. In some embodiments, the invention's processes are stored in the system memory 2120, the permanent storage device 2135, and/or the read-only memory 2130. For example, the various memory units include instructions for processing multimedia clips in accordance with some embodiments. From these various memory units, the processing unit(s) 2110 retrieves instructions to execute and data to process in order to execute the processes of some embodiments.

The bus 2105 also connects to the input and output devices 2140 and 2145. The input devices 2140 enable the user to communicate information and select commands to the electronic system. The input devices 2140 include alphanumeric keyboards and pointing devices (also called “cursor control devices”), cameras (e.g., webcams), microphones or similar devices for receiving voice commands, etc. The output devices 2145 display images generated by the electronic system or otherwise output data. The output devices 2145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 21, bus 2105 also couples electronic system 2100 to a network 2125 through a network adapter (not shown). In this manner, the computer can be a part of a network of computers (such as a local area network (“LAN”), a wide area network (“WAN”), or an Intranet), or a network of networks, such as the Internet. Any or all components of electronic system 2100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, many of the figures illustrate various touch gestures (e.g., taps). However, many of the illustrated operations could be performed via different touch gestures (e.g., double tap gesture, press and hold gesture, swipe instead of tap, etc.) or by non-touch input (e.g., using a cursor controller, a keyboard, a touchpad/trackpad, a near-touch sensitive screen, etc.). In addition, a number of the figures (including FIGS. 5 and 8) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. A method of automatically adding sound effects for graphical elements, the method comprising:
analyzing a set of properties of a graphical element;
selecting a set of sound effects clips based on the analysis of the graphical element properties;
identifying a starting time of each sound effects clip in the selected set of sound effects clips based on the analysis of the graphical element;
adjusting a duration of each sound effects clip in the set of sound effects clips based on the properties of the graphical element; and
scheduling the selected set of sound effects clips for play back, wherein said analyzing, selecting, identifying, and adjusting are performed without human intervention.

2. The method of claim 1 further comprising:
analyzing content surrounding the graphical element; and
adjusting a volume of the added set of sound effects clips based on the analysis of the surrounding content.

3. The method of claim 2, wherein analyzing the content surrounding the graphical element comprises determining an audio volume of the surrounding content, wherein adjusting the volume of the added set of sound effects clips comprises adjusting the volume of the added set of sound effects clips based on the determined audio volume of the surrounding content.

4. The method of claim 1, wherein the analyzed properties of the graphical element comprise one of type, style, starting time, and duration of the graphical element.

5. The method of claim 4, wherein the type of the graphical element comprises one of a title, a transition, and a visual filter.

6. The method of claim 1, wherein the analyzed properties of the graphical element comprise a number of animated events in the graphical element, wherein identifying the starting time of each sound effects clip in the selected set of sound effects clips comprises spotting the sound clip to the graphical element based on a starting time of a corresponding animated event in the graphical element.

7. The method of claim 1 further comprising trimming a sound effects clip in the set of sound effects clips based on a starting time of a visual animation in the content surrounding the graphical element.

8. The method of claim 1 further comprising fading a portion of a sound effects clip in the set of sound effects clips based on a starting time of a visual animation in the content surrounding the graphical element.

9. A non-transitory machine readable medium storing a program for automatically adding sound effects for graphical elements, the program executable by at least one processing units, the program comprising sets of instructions for:
analyzing a set of properties of a graphical element;
selecting a set of sound effects clips based on the analysis of the graphical element properties;
identifying a starting time of each sound effects clip in the selected set of sound effects clips based on the analysis of the graphical element;
adjusting a duration of each sound effects clip in the set of sound effects clips based on the properties of the graphical element; and
scheduling the selected set of sound effects clips for play back, wherein said analyzing, selecting, identifying, and adjusting are performed without human intervention.

10. The non-transitory machine readable medium of claim 9, the program further comprising sets of instructions for:
analyzing content surrounding the graphical element; and
adjusting a volume of the added set of sound effects clips based on the analysis of the surrounding content.

11. The non-transitory machine readable medium of claim 10, wherein the set of instructions for analyzing the content surrounding the graphical element comprises a set of instructions for determining an audio volume of the surrounding content, wherein the set of instructions for adjusting the volume of the added set of sound effects clips comprises a set of instructions for adjusting the volume of the added set of sound effects clips based on the determined audio volume of the surrounding content.

12. The non-transitory machine readable medium of claim 9, wherein the analyzed properties of the graphical element comprise one of type, style, starting time, and duration of the graphical element.

13. The non-transitory machine readable medium of claim 12, wherein the type of the graphical element comprises one of a title, a transition, and a visual filter.

14. The non-transitory machine readable medium of claim 9, wherein the analyzed properties of the visual element comprise a number of animated events in the graphical element, wherein the set of instructions for identifying the starting time of each sound effects clip in the selected set of sound effects clips comprises a set of instructions for spotting the sound clip to the graphical element based on a starting time of a corresponding animated event in the graphical element.

15. The non-transitory machine readable medium of claim 9, the program further comprising a set of instructions for trimming a sound effects clip in the set of sound effects clips based on a starting time of a visual animation in the content surrounding the graphical element.

16. The non-transitory machine readable medium of claim 9, the program further comprising a set of instructions for fading a portion of a sound effects clip in the set of sound effects clips based starting time of a visual animation in the content surrounding the graphical element.

17. An apparatus comprising:
a set of processing units for executing sets of instructions;
a non-transitory machine readable medium storing a program which when executable by one of the processing units automatically adds sound effects for graphical elements, the program executable by at least one processing units, the program comprising sets of instructions for:
analyzing a set of properties of a graphical element;
selecting a set of sound effects clips based on the analysis of the graphical element properties;
identifying a starting time of each sound effects clip in the selected set of sound effects clips based on the analysis of the graphical element;
adjusting a duration of each sound effects clip in the set of sound effects clips based on the properties of the graphical element; and
scheduling the selected set of sound effects clips for play back, wherein said analyzing, selecting, identifying, and adjusting are performed without human intervention.

18. The apparatus of claim 17, the program further comprising sets of instructions for:
analyzing content surrounding the graphical element; and
adjusting a volume of the added set of sound effects clips based on the analysis of the surrounding content.

19. The apparatus of claim 18, wherein the set of instructions for analyzing the content surrounding the graphical element comprises a set of instructions for determining an audio volume of the surrounding content, wherein the set of instructions for adjusting the volume of the added set of sound effects clips comprises a set of instructions for adjusting the volume of the added set of sound effects clips based on the determined audio volume of the surrounding content.

20. The apparatus of claim 17, wherein the analyzed properties of the graphical element comprise one of type, style, starting time, and duration of the graphical element.

21. The apparatus of claim 20, wherein the type of the graphical element comprises one of a title, a transition, and a visual filter.

22. The apparatus of claim 17, wherein the analyzed properties of the visual element comprise a number of animated events in the graphical element, wherein the set of instructions for identifying the starting time of each sound effects clip in the selected set of sound effects clips comprises a set of instructions for spotting the sound clip to the graphical element based on a starting time of a corresponding animated event in the graphical element.

23. The apparatus of claim 17, the program further comprising a set of instructions for trimming a sound effects clip in the set of sound effects clips based on a starting time of a visual animation in the content surrounding the graphical element.

24. The apparatus of claim 17, the program further comprising a set of instructions for fading a portion of a sound effects clip in the set of sound effects clips based on a starting time of a visual animation in the content surrounding the graphical element.
